(19) United States
(12) Patent Application Publication
(10) Pub. No.: US 2017/0339912 A1
(43) Pub. Date: Nov. 30, 2017

(54) ELEVATED BOARD STRUCTURE FOR RAISING POULTRY AND LIVESTOCK

(71) Applicant: CHIA-HSING HSU, Changhua (TW)

(72) Inventor: CHIA-HSING HSU, Changhua (TW)

(21) Appl. No.: 15/167,689

(22) Filed: May 27, 2016

(51) Int. Cl. A01K 1/01; A01K 1/015; A01K 1/02; A01K 31/04

(52) U.S. Cl. CPC A01K 1/0103; A01K 31/04; A01K 1/0151; A01K 1/02

(57) ABSTRACT

An apparatus for raising poultry and livestock may comprise a plurality of elevated boards configured to be assembled with each other, and each of the elevated boards has a platform. At least two paralleled supporting boards respectively protrude from a bottom portion of the platform, and a flowing channel is formed between the two supporting boards. A top surface of the platform has a plurality of holes penetrating the platform, and each of a first pair of adjacent sides of the platform has at least a connecting slot while each of a second pair of adjacent sides of the platform comprises at least a protruding piece which is configured to engage with the connecting slot when two elevated boards connected. The present invention can fit any size of the farm and prevent poultry and livestock from being infected by their excrement.

### FIELD OF THE INVENTION

The present invention relates to an elevated board apparatus, and more particularly to an apparatus for raising poultry and livestock.

### BACKGROUND OF THE INVENTION

In the early days, people raised poultry and livestock in a place which is circled by fences or barriers on the ground, and the raising place should be cleaned regularly by spraying water. However, because of the wide range of activity of poultry and livestock, droppings thereof are scattered around the ground, and over a day, that will be stuck on the ground and will be hard to clean resulting in the environment filling with foul smell. In this raising environment, the poultry and livestock may directly touch and eat their excrement thereby being cross infected, ill and dead.

Thus, for preventing poultry and livestock from being infected and raising places from being contaminated by the excrement, the owner started to raise poultry and livestock on an elevated board apparatus. When the owner raises domestic pigs on the elevated board apparatus which has a hollow structure thereon, the excrement of the domestic pigs will pass through the board apparatus and directly fall down to the ground. However, although the elevated board apparatus separates the domestic pigs from the excrement, it still has its disadvantage in low loading capacity due to its weak supports provided by legs thereof on edges. Also, while the excrement is dropped on the flat ground instead of a tilted surface, it is still hard to be cleaned that leads to some excrement left on the ground. In addition, the excrement must be cleaned by labor including spraying water and scrubbing the ground that needs to waste time and effort. Therefore, there remains a need for a new and improved design for an apparatus for raising poultry and livestock to overcome the problems presented above.

### SUMMARY OF THE INVENTION

The present invention provides an apparatus for raising poultry and livestock which comprises a plurality of elevated boards configured to be assembled with each other, and each of the elevated boards has a platform. At least two paralleled supporting boards respectively protrude from a bottom portion of the platform, and a flowing channel is formed between the two supporting boards.

Comparing with conventional elevated board apparatus, the present invention is advantageous because: (i) since the elevated boards can be assembled and disassembled, the present invention can fit any size of the farm so as to achieve the practicability of use; (ii) with the design of the supporting boards, the platforms of the elevated boards are separated from the ground with a preferred height, and combined with the holes on the platforms, the excrement of poultry and livestock can directly pass through the holes and fall to the ground instead of sticking on the platforms so as to prevent the poultry and livestock from contacting or eating their excrement resulting in infection; and (iii) the single elevated board comprises at least one flowing channel formed under the bottom portion of the platform between the two supporting boards of the elevated board, and the present invention further has the flushing unit which can be set to automatically spray water through the flushing pipes for each of the flowing channels so as to flush the excrement in the flowing channels. Thus, the present invention can efficiently achieve the cleaning effect of the ground and reduce the possibility of infection of poultry and livestock.

### BRIEF DESCRIPTION OF THE DRAWINGS

FIG. 1 is a three-dimensional assembly view of an apparatus for raising poultry and livestock in the present invention.

FIG. 2 is an exploded view of the present invention when a plurality of elevated boards of the apparatus for raising poultry and livestock are assembled.

FIG. 3 is a three-dimensional bottom view of the apparatus for raising poultry and livestock in the present invention when the elevated boards are assembled.

FIG. 4 is a sectional assembly view of the apparatus for raising poultry and livestock in the present invention when the elevated boards are assembled.

FIG. 5 is a three-dimensional of another embodiment of the single elevated board of the apparatus for raising poultry and livestock in the present invention.

FIG. 6 is a schematic assembly view of another embodiment of the apparatus for raising poultry and livestock in the present invention when the elevated boards are assembled.

FIG. 7 is a schematic assembly view of the apparatus for raising poultry and livestock in the present invention.

FIG. 8 is a schematic assembly view of the apparatus for raising poultry and livestock of the present invention in actual application.

FIG. 9 is a schematic view of cleaning process of the apparatus for raising poultry and livestock of the present invention in actual application.

FIG. 10 is a schematic view illustrating excrement of poultry and livestock is flashed by water flow in the present invention.

FIG. 11 is a three-dimensional assembly view of the apparatus for raising poultry and livestock connected to a pool in the present invention.

FIG. 12 is a sectional view of the apparatus for raising poultry and livestock to the pool in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

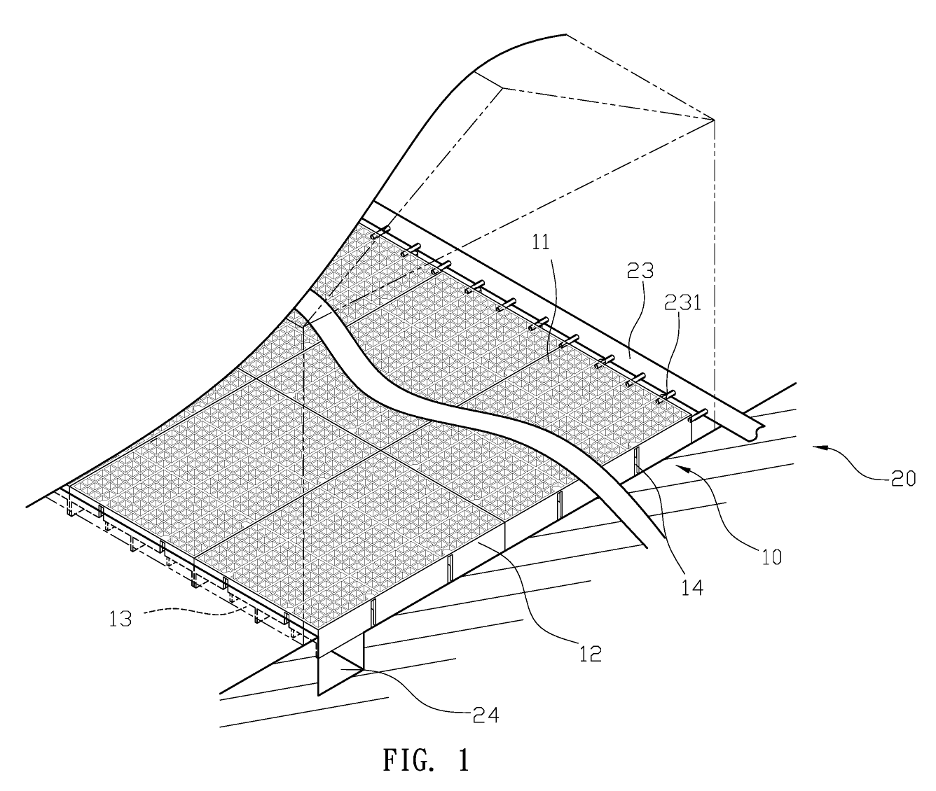

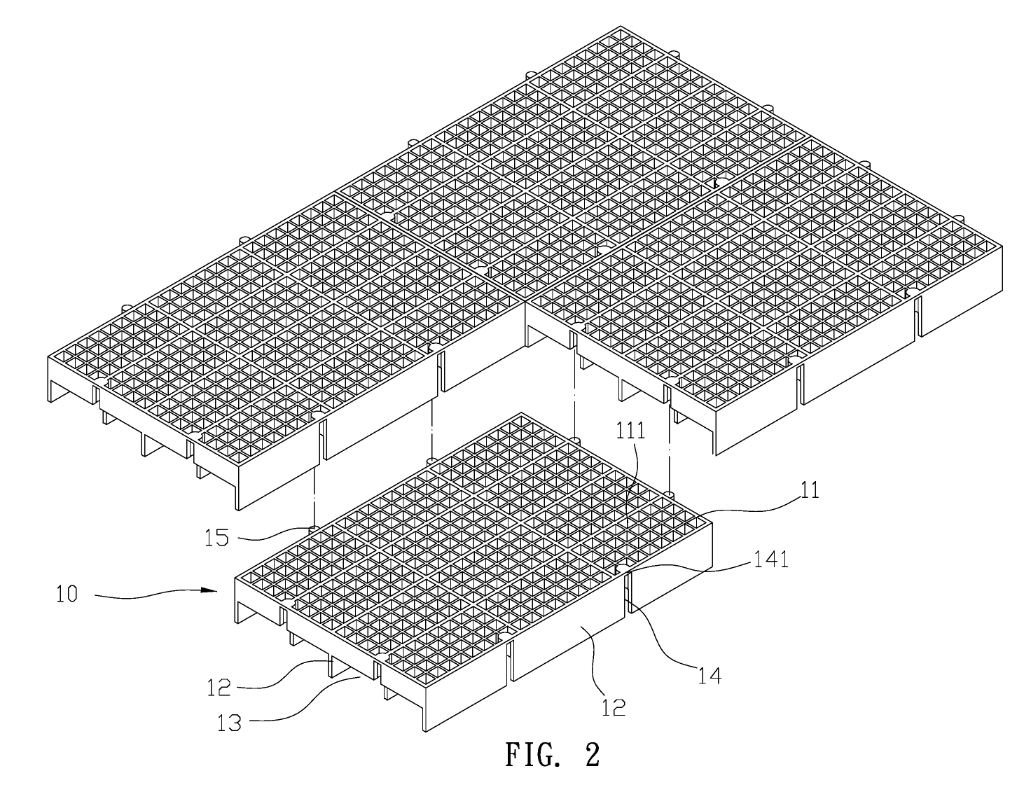

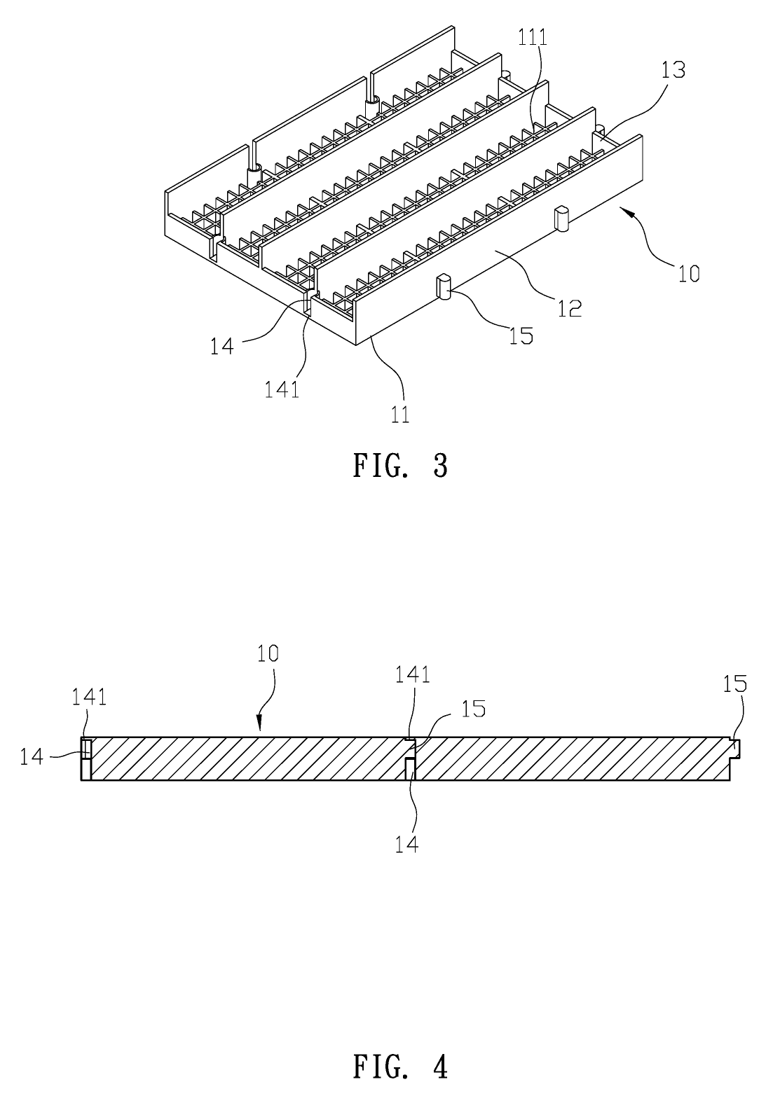

Referring to FIGS. 1 to 4, the present invention provides an apparatus for raising poultry and livestock which comprises a plurality of elevated boards (10) configured to be assembled with each other, and each of the elevated boards (10) has a platform (11). At least two paralleled supporting boards (12) respectively protrude from a bottom portion of the platform (11), and a flowing channel (13) is formed between the two supporting boards (12). In one embodiment, the single elevated board (10) has a plurality of the paralleled supporting boards (12) thus forming a plurality of the flowing channels (13). A top surface of the platform (11) comprises a plurality of holes (111) penetrating through the platform (11), and each of a first pair of adjacent sides of the platform (11) has at least a connecting slot (14). Also, each of a second pair of adjacent sides of the platform (11) comprises at least a protruding piece (15) which is configured to engage with the connecting slot (14) when two elevated boards (10) are connected. A top end of the connecting slot (14) comprises a blocking portion (141) which is configured to bear against and limit a position of the protruding piece (15).

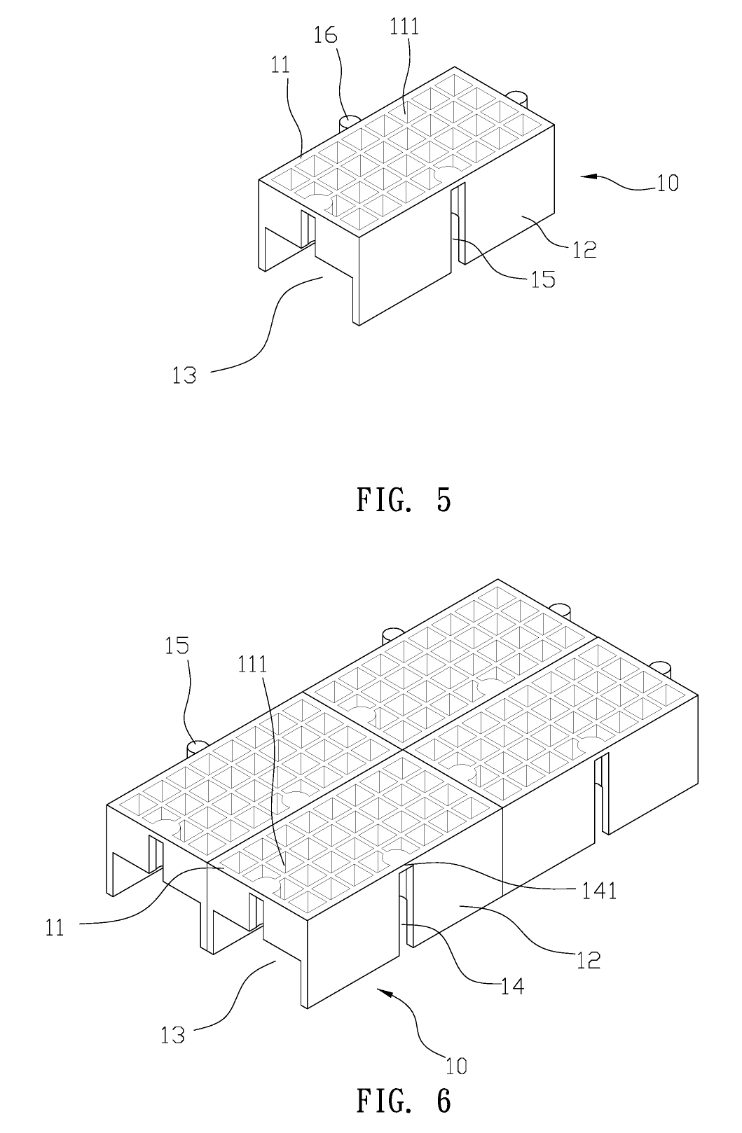

In another embodiment, referring to FIGS. 5 and 6, the dimension of the elevated board (10) is smaller, and only two parallel supporting board (12) respectively protrude from the bottom portion of the platform (11), and the flowing channel (13) is formed between the two supporting board (12). Each of the first pair of adjacent sides comprises one connecting slot (14) while each of the second pair of adjacent sides has one protruding piece (15).

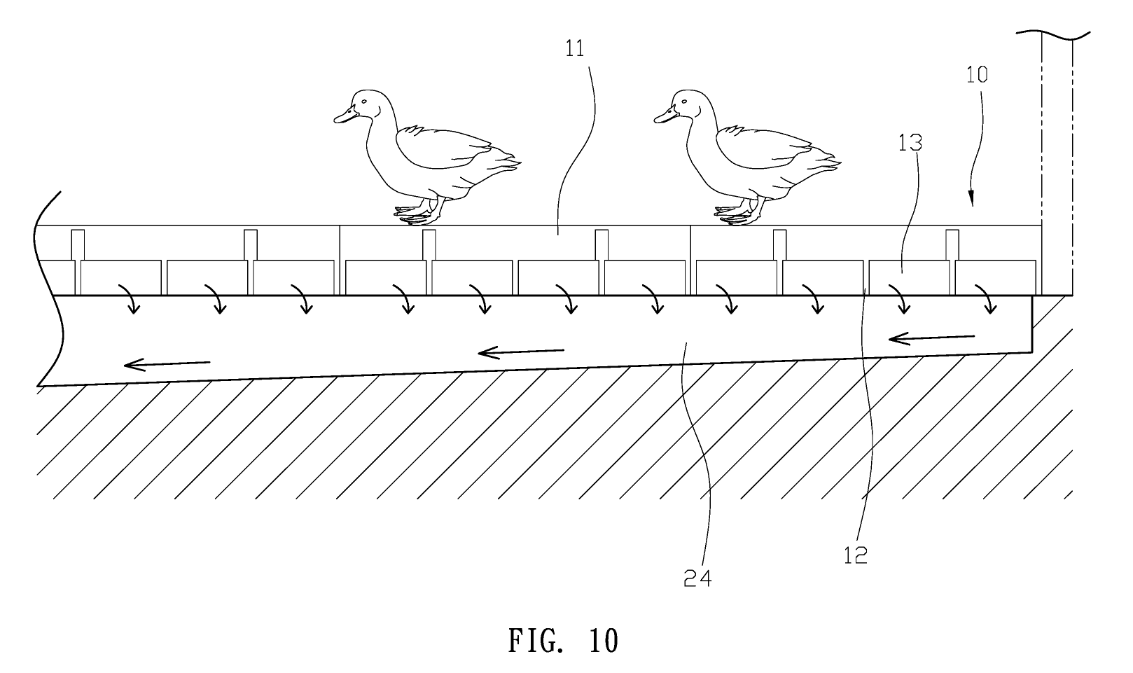

Structurally, referring to FIGS. 1, 2 and 7, the elevated boards (10) are settled on a ground (20) of a farm, and through the supporting boards (12), the planforms (11) of the elevated boards (10) are separated from the ground (20) with a preferred height. Wherein the ground (20) is slightly tilted and has a flushing end (21) and a discharging end (22), and the elevated boards (10) are connected and arranged along the tilted direction of the ground (20) from the flushing end (21) to the discharging end (22) to allow the flowing channels (13) to be parallel with the tilted direction. By engaging the connecting slot (14) with the protruding piece (15) and the design of the blocking portion (141), the two or more elevated boards (10) can be firmly connected, and also the protruding pieces (15) can be settled inside the connecting slots (14) instead of protruding from the surface of the platform (11) thereby improving the flatness of the elevated boards (10). Furthermore, the flushing end (21) located at higher edge of the ground (20) has a flushing unit (23) which comprises at least a flushing pipe (231) formed at a location corresponding to the flowing channel (13). On the other hand, the discharging end (22) located at lower edge of the ground (20) further is connected to a discharging groove (24) which is tilted with a preferred angle from one end to the other end thereof (as shown in FIG. 10).

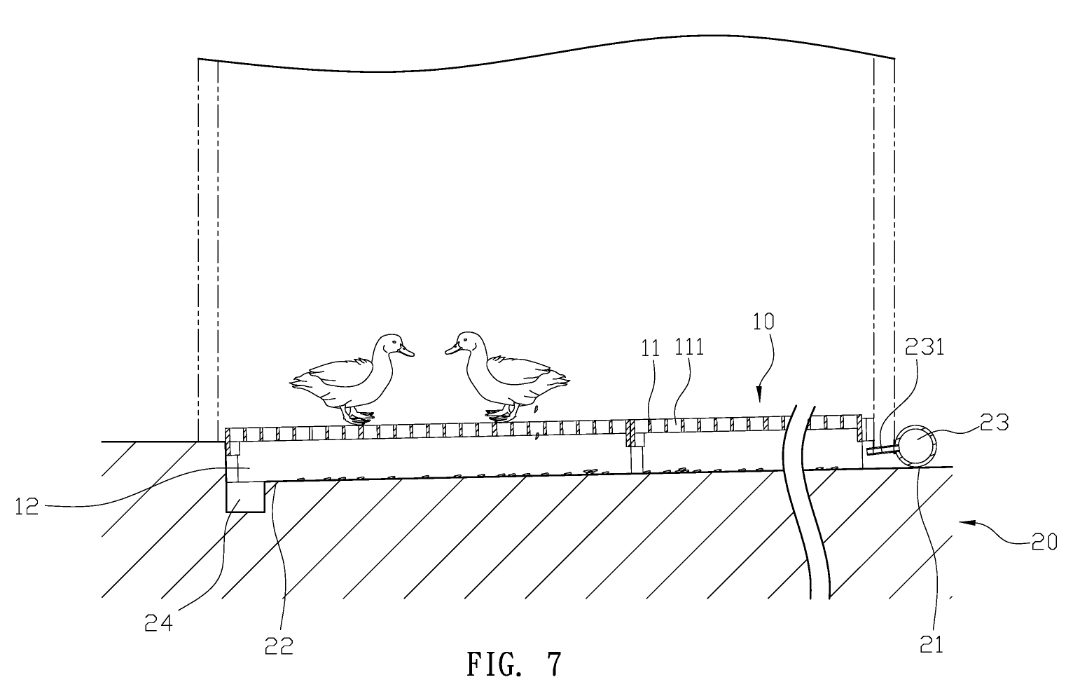

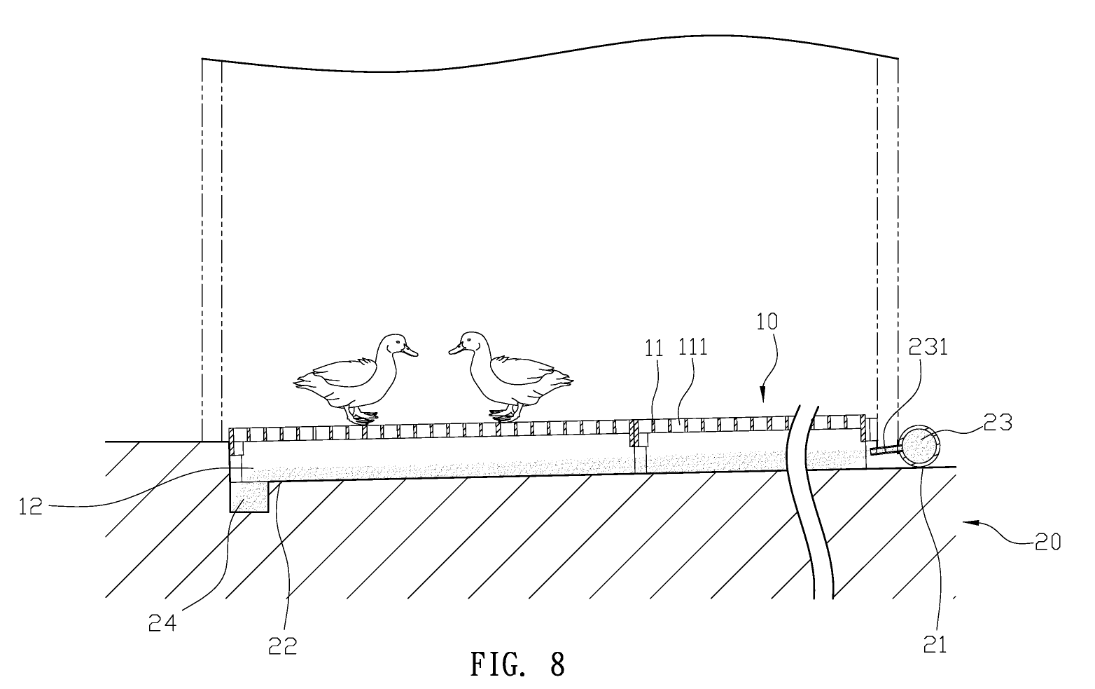

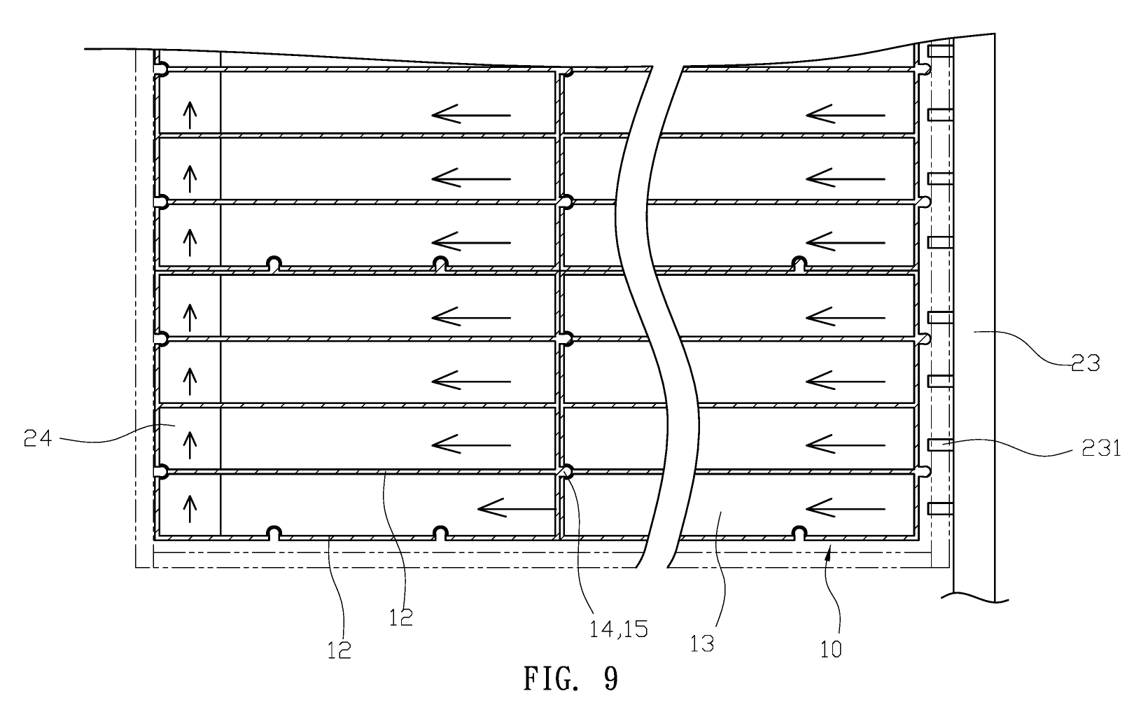

In actual application, referring to FIGS. 7 to 10, the poultry and livestock can be raised on the assembled elevated boards (10), and through the supporting boards (12) bearing against the ground (20), the platforms (11) of the elevated boards (10) can be separated from the ground (20) with a preferred height. Thus, the excrement of poultry and livestock can directly fall to the ground (20) through the holes (111) rather than be left on the platforms (11) so as to reduce the possibility of infection of poultry and livestock. Also, the flushing end (21) of the ground (20) has the flushing unit (23) which can be set to automatically spray water through the flushing pipes (231) for the flowing channels (13) and the excrement can be flushed along the flowing channels (13) toward the discharging end (22) into the discharging groove (24). Since the flushing pipes (231) are respectively located at positions corresponding to the flowing channels (13) of the elevated boards (10), the flushing unit (23) can provide sufficient water flow to flush the excrement in the flowing channels (13) to the discharging groove (24) thus efficiently cleaning the ground (20) and preventing the poultry and livestock from being infected by the excrement.

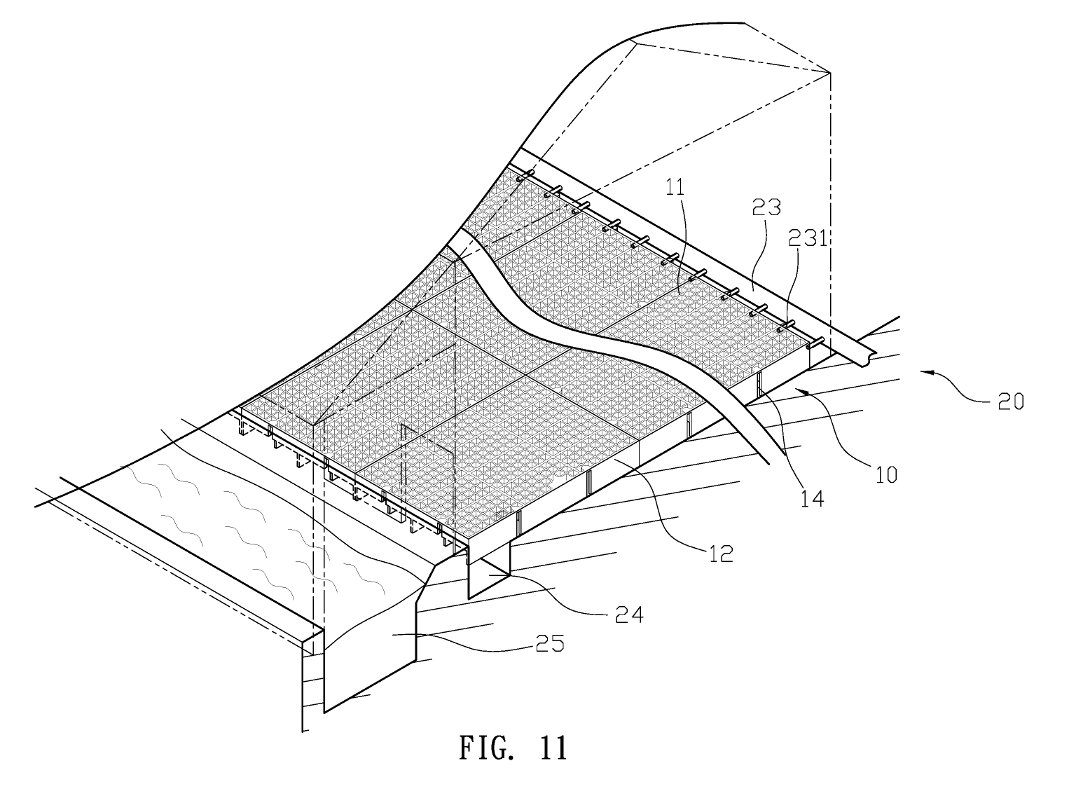

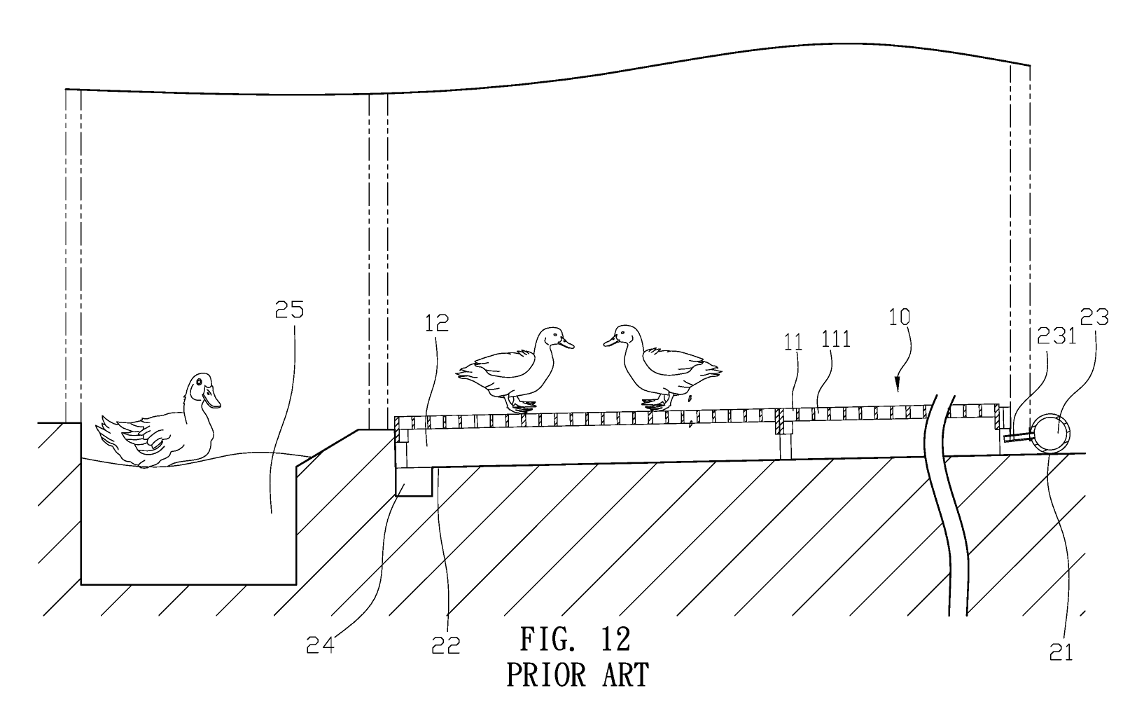

Additionally, a pool (25) is settled on the ground (20) adjacent to the elevated boards (10), referring to FIGS. 11 and 12, and the depth of the pool (25) is deeper than the discharging groove (24). A first end of the pool (25) near the elevated boards (10) comprises a blocking wall (251) which is configured to bear against an edge of the elevated boards (10), and the height of the blocking wall (251) is shorter than the platforms (11) of the elevated boards (10) so as to allow the poultry and livestock to enter to the pool (25) thereby keeping the clean of poultry and livestock.

Comparing with conventional elevated board apparatus, the present invention is advantageous because: (i) since the elevated boards (10) can be assembled and disassembled, the present invention can fit any size of the farm so as to achieve the practicability of use; (ii) with the design of the supporting boards (12), the platforms (11) of the elevated boards (10) are separated from the ground (20) with a preferred height, and combined with the holes (111) on the platforms (11), the excrement of poultry and livestock can directly pass through the holes (111) and fall to the ground (20) instead of sticking on the platforms (11) so as to prevent the poultry and livestock from contacting or eating their excrement resulting in infection; and (iii) the single elevated board (10) comprises at least one flowing channel (13) formed under the bottom portion of the platform (11) between the two supporting boards (12) of the elevated board (10), and the present invention further has the flushing unit (23) which can be set to automatically spray water through the flushing pipes (231) for each of the flowing channels (13) so as to flush the excrement in the flowing channels (13). Thus, the present invention can efficiently achieve the cleaning effect of the ground (20) and reduce the possibility of infection of poultry and livestock.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An apparatus for raising poultry and livestock comprising a plurality of elevated boards configured to be assembled with each other to become an assembled elevated board, and each of the elevated boards having a platform, at least two paralleled supporting boards respectively protruding from a bottom portion of the platform, and a flowing channel formed between the two supporting boards, a top surface of the platform comprising a plurality of holes penetrating through the platform, each of a first pair of adjacent sides of the platform having at least a connecting slot while each of a second pair of adjacent sides of the platform comprising at least a protruding piece which is configured to engage with the connecting slot when two elevated boards connected.

2. The apparatus for raising poultry and livestock of claim 1, wherein the platform has a plurality of the paralleled supporting boards protruding from the bottom portion thereof to form a plurality of the flowing channels.

3. The apparatus for raising poultry and livestock of claim 1, wherein the platform only has the two paralleled supporting boards protruding from the bottom portion thereof to form the flowing channel.

4. The apparatus for raising poultry and livestock of claim 1, wherein a top end of the connecting slot has a blocking portion which is configured to bear against and limit a position of the protruding piece.

5. The apparatus for raising poultry and livestock of claim 1, wherein the assembled elevated board is settled on a ground of a farm, wherein the ground is slightly tilted toward a direction to define a flushing end and a discharging end respectively formed at an upper edge and a lower edge of the ground, and the assembled elevated board is arranged in a direction same as to the tilted direction of the ground so as to allow two ends of each of the flowing channels to be respectively located at the upper edge and the lower edge of the ground, wherein the flushing end has a flushing unit which further comprises at least a flushing pipe, and the number of the flushing pipe is the same as the flowing channel such that each of the flushing pipes is configured to provide water flow for the corresponding flowing channel, and the discharging end has a discharging groove.

6. The apparatus for raising poultry and livestock of claim 5, wherein the discharging groove is tilted toward a direction.

7. The apparatus for raising poultry and livestock of claim 5, wherein a pool is settled on the ground adjacent to the assembled elevated board, and a depth of the pool is deeper than the discharging groove, and a first end of the pool close to the assembled elevated board comprises a blocking wall which is configured to bear against an edge of the assembled elevated board thereby limiting a position thereof, the assembled elevated board has an assembled platform formed on a top surface thereof, and a vertical height of the blocking wall is lower than the assembled platform.
